(19) United States
(12) Patent Application Publication
(10) Pub. No.: US 2002/0131703 A1
(43) Pub. Date: Sep. 19, 2002

(54) Fiber-lens coupling system and method of manufactuing thereof

(76) Inventor: Leonid Velikov, San Carlos, CA (US)

Correspondence Address: Leonid Velikov, 1371 Greenbrier Rd., San Carlos, CA, 94070, US

(21) Appl. No.: 09/810,598

(22) Filed: Mar. 15, 2001

(51) Int. Cl. G02B 6/32

(52) U.S. Cl. 385/35; 385/33

(57) ABSTRACT

The multiple fiber-lens coupling system of the invention comprises a plurality of individual optical fibers assembled into a bundle where each fiber is guided through at least one pair of plates with a plurality of aligned openings arranged in a pattern identical to the pattern of microlenses formed into a matrix or an array. The ends of the optical fibers are aligned so that they are arranged in a common plane, and the aforementioned at least one pair of plates is located close to the fiber ends so that the ends of the fibers do not sag. The plates are moveable with respect to each other in the direction perpendicular to the direction of the fibers, so that when one of the plates or both plates are moved with respect to each other, the openings are slightly overlapped, and the ends of the fibers are squeezed between the edges of the openings. Microadjustment of the movement of the plates will cause shifting of the fiber ends with respect to the lenses. In the manufacture of the system, the ends of the pre-assembled bundle of optical fibers are inserted into the respective crater-like projections and self-aligned in the tapered flat-bottom “craters”. The microlenses have focal points preferably, but not necessarily, coinciding with the flat bottoms of the crates, i.e., with end faces of the optical fibers in their aligned position.

### FIELD OF THE INVENTION

The present invention relates to the field of optical fiber communication, in particular, to devices for coupling a bundle of individual optical fibers to a matrix or array of optical lenses or other optical components.

### BACKGROUND OF THE INVENTION

One problem that exists in the field of optical fiber communication is an optical coupling of a plurality of individual optical fibers assembled into a bundle to a plurality of respective individual optical lenses, in particular, microlenses combined into a lens matrix or a lens array. The problem is associated with miniature dimensions of the components to be assembled into a plurality of individual optical data transmission channels. Each such channel includes an optical fiber optically aligned and coupled with a respective microlens so as manage an optical beam of light to be transmitted through the optical fiber channel. In the context of the present invention, the term “optical fiber channel” means an individual optical path associated with an individual optical fiber.

In connecting one optical fiber or several optical fibers to equivalent amount of microlenses, the aforementioned optical alignment and coupling are technically resolvable problem. For example, such a problem occurs in coupling a laser diode to an optical fibers used as a light-wave guide. The main technical difficulty that occurs in such an application is an angular asymmetry of radiation from a laser diode. It is required that in focusing individual light beams into the respective optical fiber such angular asymmetry be compensated by the optical system, e.g., with the use of aspheric or even anamorphotic optics or microoptics. In addition to angular asymmetry, the optical axis of each individual optical fiber must always be aligned with the optical axis of a respective microlens. This can be done by utilizing a microactuator for three-dimensional displacement of the ends of the optical fibers with respect to the lenses in combination with rotation of the fiber axes in two planes with respect to points in the centers on input ends of the fiber cores. See, e.g., UK Patent No. 2,327,278 issued on Jan. 20, 1999 to Hiroshi Kanazawa, U.S. Pat. No. 4,290,667 issued on Sep. 22, 1981 to Martin Chown, etc.

U.S. Pat. No. 5,400,429 issued to Gregory H. Ames on Mar. 21, 1995 describes a method for making a fiber-optic bundle collimator assembly by assembling side by side a multiplicity of first bodies of cylindrical configuration and equal diameter and applying a uniform compressive force to the first bodies to force the first bodies into a predictable hexagonal pattern of minimum diameter. Additional bodies of cylindrical configuration having diameters equal to the diameters of the first bodies are inserted on each of the sides of the bundle of first bodies with each of the additional bodies abutting two of the first bodies. A plurality of the first bodies is then removed from the bundle. Each of the removed first bodies is replaced with a pair of cylindrically-shaped second bodies having diameters equal to the diameters of the first bodies, with one of the pair protruding from the bundle on a first face thereof and another of the pair protruding from the bundle on a second face thereof. A clamp is applied to exposed portions of the second bodies at one of the bundle first and second faces, to force the second bodies into an attitude parallel to each other, the second bodies causing the first bodies to align parallel to the second bodies and parallel to each other. An outer ring of the first bodies is locked in place and a second plurality of first bodies is removed from the bundle. A plurality of optical fiber bearing ferrules is inserted in the place of the removed first bodies. Each of the first, additional and second cylindrical bodies may comprise standard optical fibers of equal diameters, e.g., of 125 μm. The aforementioned protruding ends of the fibers form recesses for insertion of ball microlenses or cylindrical gradient lenses, which are optically matched with the end faces of the optical fibers located under the lenses on one side of the bundle and above the lenses on the other side of the bundle.

The aforementioned structure forms a self-aligned multiple-fiber optical system consisting of a plurality of optical fibers coupled to a plurality of optical microlenses.

Although the system described above is advantageous in that it provides a simple and effective method for self-alignment and self-coupling of a plurality of microlens-fiber pairs, it has a number of significant disadvantages. First, it is suitable only for cylindrical GRIN lenses or spherical (“ball”) lenses, which, as known, are inferior to high-quality aspherical optics with regard to reliability of coupling. Second, the input aperture of the aforementioned lenses has a fixed value, which is strictly related to the diameter of the fiber and cannot be increased to a desired value, if required. Therefore such lenses are not suitable for many applications. Finally, the entire arrangement is applicable only to a hexagonal or rectangular (square) lattice, so that the use of such bundles in some applications, e.g., in MEMS systems for management of individual optical beams arranged into a matrix pattern, is difficult or impossible.

U.S. Pat. No. 5,550,942 issued to Sang K. Sheem on Aug. 27, 1996 describes a multiple fiber-lens coupling system and manufacturing methods for optical fiber connector plugs and sleeves. According to this invention, precision holes are fabricated through a thin slab, preferably using preferential etching technique on a semiconductor wafer, such as silicon or gallium arsenide. The angle of the slope is specific in the preferentially etched through-holes. Optical fibers are inserted into the V-shaped through-holes, with the orientation perpendicular to the surface of the slab. The aforementioned slab with a plurality of etched square-shaped holes with the square side equal to the diameter of the fiber can be used for holding and managing the end faces of optical fibers assembled into a bundle. The fibers arranged in such matrix-type slab can be used for subsequent coupling of the fibers to microlenses.

A disadvantage of the system described above consists in that the method and device involve anisotropic etching of silicon slabs, which requires matching of the etching process with the specific orientation inherent in the silicone crystal. Furthermore, the fibers arranged in the holes of the slab cannot be easily optically matched with microlenses since positions of the fiber ends are not adjustable.

Thus, none of the prior-art techniques described above makes it possible to simply and reliably align a bundle of individual optical fibers in an amount of hundreds to thousands with equal amounts of microlenses arranged into a matrix or an array form.

### OBJECTS OF THE INVENTION

It is an object of the invention to provide a multiple fiber-lens coupling system and method for self-aligning and coupling a bundle of individual optical fibers to a matrix or array of respective optical lenses in a simple and reliable manner. Another object is to provide aforementioned system and method for arranging the optical fibers in a lattice structure with matching and coupling of the fiber ends to respective microlenses. Still another object is to provide a method and system for simple and convenient fixation of a plurality of fiber-lens pairs in an optimal optically-matched positions. Another object is to provide the aforementioned method and system that ensure self-aligning of the fibers with the microlenses during optical matching. Another object is to provide the aforementioned system, which is inexpensive to manufacture and is suitable for mass production.

### BRIEF DESCRIPTION OF THE DRAWINGS

FIG. 1 is a side sectional view of a multiple fiber-lens coupling system of the present invention for an embodiment with a microlens array.

FIG. 2 is a sectional view along the line II-II of FIG. 1.

FIG. 3 is a view of the microlens array of FIG. 1 in the direction of arrow A in FIG. 1.

FIG. 4 is a view of the microlens array of FIG. 1 in the direction of arrow B in FIG. 1.

FIG. 5 is a cross-sectional view of a lens array consisting of two separate parts and shown in a disassembled state.

FIG. 6 is a view similar to FIG. 1 but for an embodiment with a microlens matrix.

FIG. 7 is a view along the line VII-VII of FIG. 6.

FIG. 8 is a view similar to FIG. 7 but with a hexagonal arrangement of the optical fibers.

FIG. 9 is a fragmental sectional side view of a fiber-clamping device made according to another embodiment of the invention.

FIG. 10 is a fragmental sectional view of a microlens array/matrix in which the fiber-aligning craters are replaced by flat-bottom tapered holes coaxial with the respective microlenses.

FIG. 11 is a three-dimensional view of a portion of a microlens matrix with tapered fiber-aligning cells formed by mutually perpendicular grooves.

### SUMMARY OF THE INVENTION

The multiple fiber-lens coupling system of the invention comprises a plurality of individual optical fibers assembled into a bundle where each fiber is guided through at least one pair of plates with a plurality of aligned openings arranged in a pattern identical to the pattern of microlenses formed into a matrix or an array. The ends of the optical fibers are aligned so that they are arranged in a common plane, and the aforementioned at least one pair of plates is located close to the fiber ends so that the ends of the fibers do not sag. This can also be achieved by arranging the fibers in a vertical direction. The diameters of the openings slightly exceed the diameters of the fibers, and the plates are moveable with respect to each other in a direction perpendicular to the direction of the fibers, so that when one of the plates or both plates are moved with respect to each other, the openings are slightly overlapped, and the ends of the fibers are squeezed between the edges of the openings. Microadjustment of the movement of the plates will cause shifting of the fiber ends with respect to the lenses. The lens array is formed in the form of a plate made of an optical material with convex lenses on the side of the plate opposite to the fibers and with tapered crater-like flat-bottom projections on the side facing the fiber ends. In the manufacture of the system, the ends of the pre-assembled bundle of optical fibers are inserted into the respective crater-like projections and self-aligned in the tapered flat-bottom “craters”. The microlenses have focal points preferably, but not necessarily, coinciding with the flat bottoms of the crates, i.e., with end faces of the optical fibers in their aligned position. After alignment is achieved and checked by the positions of light spots, e.g., with the use of Spiricon camera or the like, the adjusted positions of the fibers are fixed by curing a layer of a UV-curable glue which has been applied onto the crater-side of the plate prior to insertion of the fibers. The curing is carried out by light propagated from the lens-side of the plate.

### DETAILED DESCRIPTION OF THE INVENTION

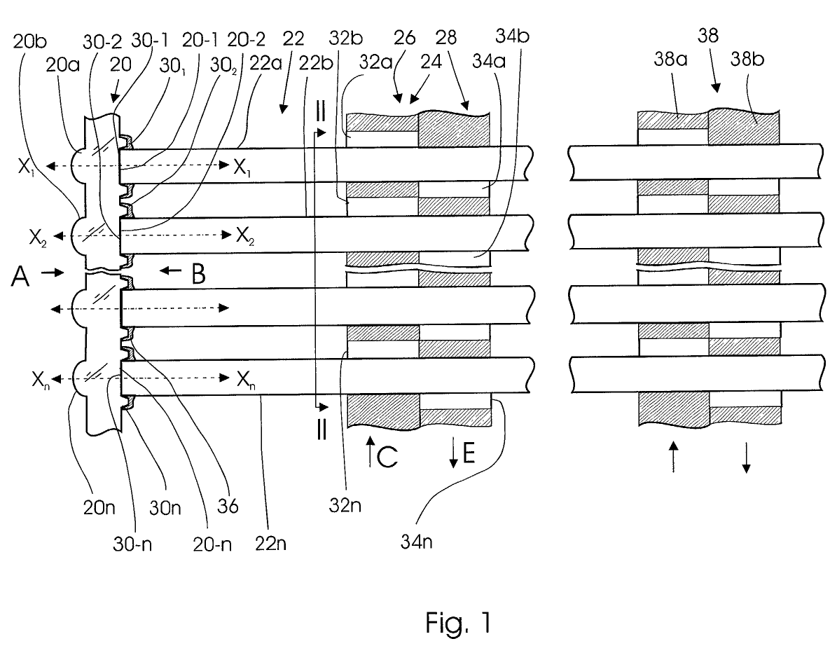

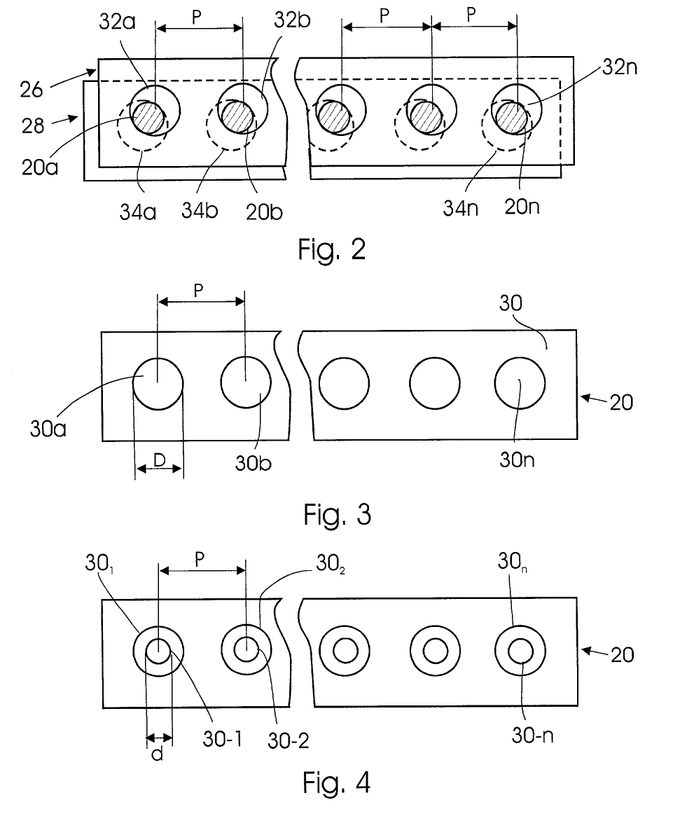

A multiple fiber-lens coupling system of the invention is shown in FIG. 1, which is a side sectional view of the system. As shown in this drawing, the system comprises an array 20 of microlenses 20a, 20b, . . . 20n, a bundle 22 of optical fibers 22a, 22b, . . . 22n, and at least one fiber-clamping device 24 formed by at least two perforated plates 26 and 28. FIG. 2 is a sectional view along the line II-II of FIG. 1, and FIG. 3 is a view of the microlens array 20 in the direction of arrow A in FIG. 1. FIG. 4 is a view of the microlens array 20 in the direction of arrow B.

In the context of the present invention, the term “clamping” does not mean application of a shear force to the optical fiber in the direction perpendicular to the longitudinal direction of the fibers and hence of the optical axis of the system, but rather means restriction of the fiber against movements in the aforementioned direction.

As shown in FIGS. 3 and 4, the lens array comprises a longitudinal plate 30 made of an optical material, such as quartz or glass which has on one side convex microlenses 30a, 30b, . . . 30n equally spaced from each other with a pitch P and on the other side crater-like projections 30₁, 30₂, . . . 30ₙ. The crater-like projections 30₁, 30₂, . . . 30ₙ are aligned with the respective microlenses 30a, 30b, . . . 30n and are arranged with the same pitch P. The crater-like projections 30₁, 30₂, . . . 30ₙ have respective flat bottoms 30-1, 30-2, . . . 30-n. The aforementioned flat bottoms 30-1, 30-2, . . . 30-n are strictly perpendicular to optical axes X1-X1, X2-X2, . . . Xn-Xn of the microlenses 30a, 30b, . . . 30n.

The microlenses 30a, 30b, . . . 30n should have a diameter D smaller than P, and the flat bottoms 30-1, 30-2, . . . 30-n of the respective crater-like projections 30₁, 30₂, . . . 30ₙ should have a diameter d equal to or slightly greater than the diameter of the optical fibers 22a, 22b, . . . 22n.

The plate 26 (FIG. 1) has an array of openings 32a, 32b, . . . 32n arranged with the same pitch P as the microlenses 20a, 20b, . . . 20n. The plate 28 also has a plurality of openings 34a, 34b, . . . 34n which are equal in diameter to the openings 32a, 32b, . . . 32n and are arranged in the same predetermined pattern as the openings 32a, 32b, . . . 32n. At least one of the plates 26 and 28, or both plates 26 and 28, can be moved with respect to the other, or with respect to each other, in directions shown in FIG. 1 by arrows C and E.

Normally the openings 32a, 32b, . . . 32n and the openings 34a, 34b, . . . 34n of both plates 26 and 28 are aligned so that are aforementioned optical fibers 20a, 20b, . . . 20n can be easily guided through these openings.

The aforementioned plates 26 and 28 are located close to the fiber ends so that the ends of the fibers do not sag. This can be achieved also by arranging the fibers in a vertical direction (not shown). The openings 32a, 32b, . . . 32n and the openings 34a, 34b, . . . 34n have diameters slightly exceeding the diameters of the fibers but smaller than pitch P.

The end faces 20-1, 20-2, . . . 20-n of the optical fibers 22a, 22b, . . . 22n are cut strictly perpendicular to the longitudinal directions of respective fibers so that when these ends are inserted into respective crater-like projections 30₁, 30₂, . . . 30ₙ, the end faces 20-1, 20-2, . . . 20-n of the respective optical fibers 22a, 22b, . . . 22n come into a gap-free optical butt connection with the flat surface of the crater bottoms 30-1, 30-2, . . . 30-n. It is required that even without an optically-matched glue the aforementioned contact ensure reliable propagation of light from the fibers 22a, 22b, . . . 22n to the lens array 20. The fiber end faces 20-1, 20-2, . . . 20-n are fixed to the crater-like projections 30₁, 30₂, . . . 30ₙ by means of an optical glue, preferably a UV curable glue 36.

If he fiber bundle 22 has a significant length, it can be supported by several fiber clamping devices, one of which is shown in FIG. 1 and designated by reference numeral 38. The fiber-clamping device 38 may have the same construction as the fiber-clamping device 24 and may consist of two plates 38a and 38b. If necessary, however, the auxiliary fiber-supporting device may comprise a single perforated plate, such as the plate 26 or 28.

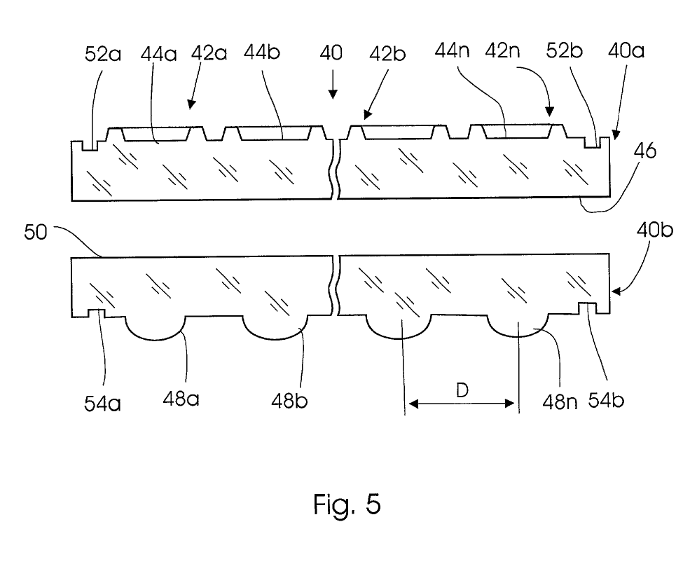

FIG. 5 is an cross-sectional view of a lens array 40 consisting of two separate parts 40a and 40b shown in a disassembled state. The part 40a is a lens-array plate with crater projections 42a, 42b, . . . 42n having flat bottoms 44a, 44b, . . . 44n. On the side opposite to the crater projections 42a, 42b, . . . 42n, the plate 40a has a flat surface 46 which has a high degree of flatness and is strictly parallel to the flat bottoms 44a, 44b, . . . 44n of the crater projections 42a, 42b, . . . 42n. The part 40b is a lens-array plate with a plurality of convex microlenses 48a, 48b, . . . 48n which are equally space from each other with the same pitch P as in the previous embodiment shown in FIGS. 1-4, provided that the fiber bundle and the fiber-clamping device are the same as described above. On the side opposite to the microlenses 48a, 48b, . . . 48n, the plate 40b has a flat surface 50 which has a high degree of flatness.

The plates 40a and 40b have respective alignment marks. Although at least three alignment marks are needed for each plate, only two of them, i.e., 52a and 52b are shown in the plate 40a and 54a and 54b are shown in the plate 40b. These marks are used for alignment of the microlenses 48a, 48b, . . . 48n of the plate 40b with the crater projections 42a, 42b, . . . 42n of the plate 40a when the plates 40a and 40b are assembled into a lens array and fixed together, e.g., with an optically matched glue (not shown) applied onto the flat surfaces 46 and 50, or at least onto one of them.

The construction of the composite lens array shown in FIG. 5 is convenient for manufacturing of the lens array, since it is more convenient and less expensive to manufacture each plate 40a and 40b separately in individual single-sided photolithography processes.

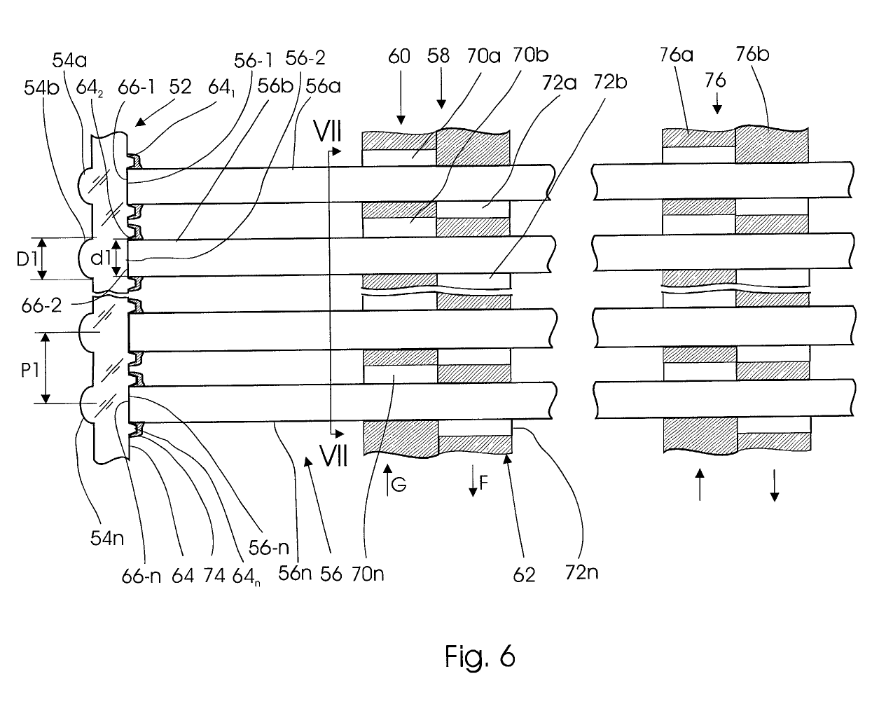

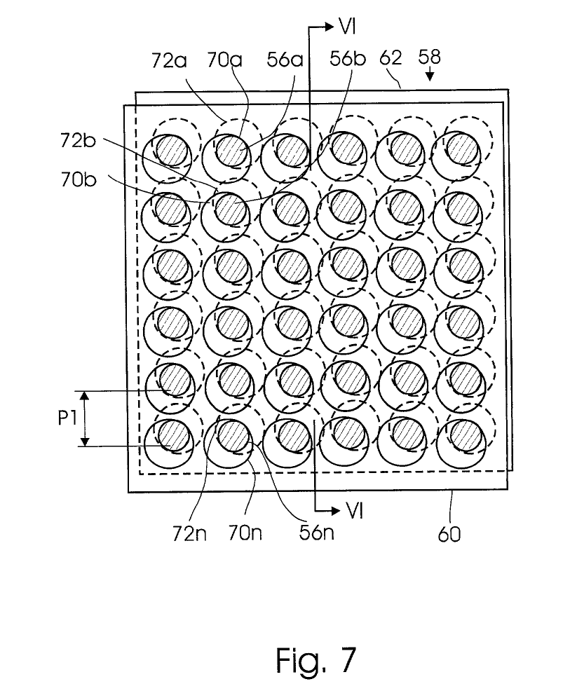

A matrix-type fiber-lens coupling system made in accordance with another embodiment of the invention is shown in FIGS. 6-10, where FIG. 6 is identical to FIG. 1 and differs from FIG. 1 only in that it is a cross section along the line VI-VI of FIG. 7 which is a view along the line VII-VII of FIG. 6. As shown in FIGS. 6 and 7, the system comprises a matrix 52 of microlenses 54a, 54b, . . . 54n, a bundle 56 of optical fibers 56a, 56b, . . . 56n, and at least one fiber-clamping device 58 formed by at least two perforated plates 60 and 62.

The lens matrix 52 (FIG. 6) comprises a rectangular, e.g., a square plate 64 made of an optical material, such as quartz or glass which has on one side the aforementioned convex microlenses 54a, 54b, . . . 54n arranged in a matrix pattern and equally spaced from each other with a pitch P1 and on the other side crater-like projections 64₁, 64₂, . . . 64ₙ. The crater-like projections 64₁, 64₂, . . . 64ₙ are aligned with the respective microlenses 54a, 54b, . . . 54n and are arranged with the same pitch P1. The crater-like projections 64₁, 64₂, . . . 64ₙ have respective flat bottoms 66-1, 66-2, . . . 66-n. As shown in FIG. 6, the fibers 56a, 56b, . . . 56n in the fiber-clamping mechanism 58, and hence the microlenses 54a, 54b, . . . 54n in the microlens matrix 52 have rectangular, in particular, square matrix arrangements (FIG. 7).

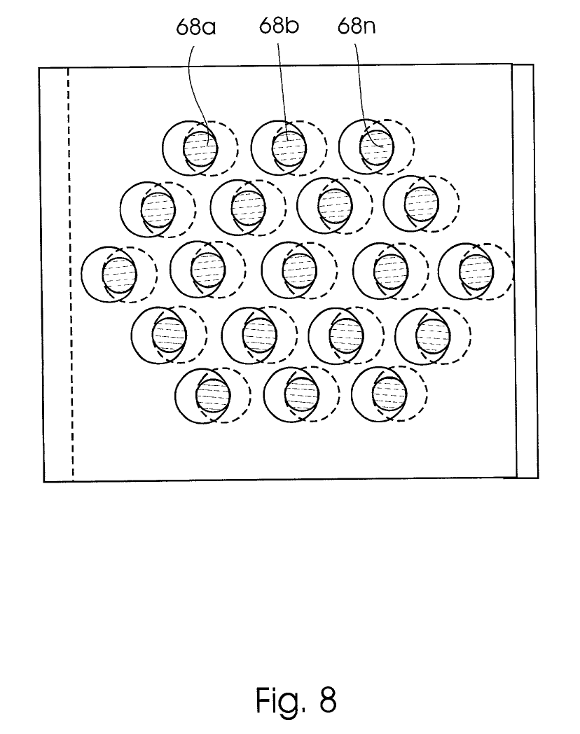

FIG. 8 is similar to FIG. 7 and shows a hexagonal arrangement of optical fibers 68a, 68b, . . . 68n. It is understood that the microlenses (not shown) of the embodiment of FIG. 8 also will have the same matrix arrangement as the optical fibers 68a, 68b, . . . 68n.

The microlenses 54a, 54b, . . . 54n (FIG. 6) should have a diameter D1 smaller than P1, and the flat bottoms 66-1, 66-2, . . . 66-n of the respective crater-like projections 64₁, 64₂, . . . 64ₙ should have a diameter d1 equal to or slightly greater than the diameter of the optical fibers 56a, 56b, . . . 56n (FIG. 7).

The plate 60 (FIG. 7) has a matrix of openings 70a, 70b, . . . 70n arranged with the same pitch P1 as the microlenses 54a, 54b, . . . 54n. The plate 62 also has a plurality of openings 72a, 72b, . . . 72n which are equal or exceed in diameter the openings 70a, 70b, . . . 70n and are arranged in the same predetermined pattern as the openings 70a, 70b, . . . 70n. At least one of the plates 60 and 62, or both plates 60 and 62, can be moved with respect to the other, or with respect to each other, in directions shown in FIG. 6 by arrows G and F.

Normally the openings 70a, 70b, . . . 70n and the openings 72a, 72b, . . . 72n of both plates 60 and 62 are aligned so that are aforementioned optical fibers 56a, 56b, . . . 56n can be easily guided through these openings.

The aforementioned plates 60 and 62 are located close to the fiber ends so that the ends of the fibers do not sag. This can be achieved also by arranging the fibers in a vertical direction (not shown). The openings 70a, 70b, . . . 70n and the openings 72a, 72b, . . . 72n have diameters slightly exceeding the diameters of the fibers but smaller than pitch P1.

The end faces 56-1, 56-2, . . . 56-n of the optical fibers 56a, 56b, . . . 56n are cut strictly perpendicular to the longitudinal directions of respective fibers so that when these ends are inserted into respective crater-like projections 64₁, 64₂, . . . 64ₙ, the end faces 56-1, 56-2, . . . 56-n of the respective optical fibers 56a, 56b, . . . 56n come into a gap-free optical butt connection with the flat surface of the crater bottoms 66-1, 66-2, . . . 66-n. It is required that even without an optically-matched glue the aforementioned contact ensure reliable propagation of light from the fibers 56a, 56b, . . . 56n to the lens matrix 52. The fiber end faces 56-1, 56-2, . . . 56-n are fixed to the crater-like projections 64₁, 64₂, . . . 64ₙ by means of an optical glue, preferably a UV curable glue 74.

If the fiber bundle 56 has a significant length, it can be supported by several fiber clamping devices, one of which is shown in FIG. 6 and designated by reference numeral 76. The fiber-clamping device 76 may have the same construction as the fiber-clamping device 58 and may consist of two plates 76a and 76b. If necessary, however, the auxiliary fiber-supporting device may comprise a single perforated plate, such as the plate 60 or 62.

It is understood that the lens matrix shown in FIG. 6 also may consist of two separate plates of the type shown in FIG. 5 and glued together with alignment.

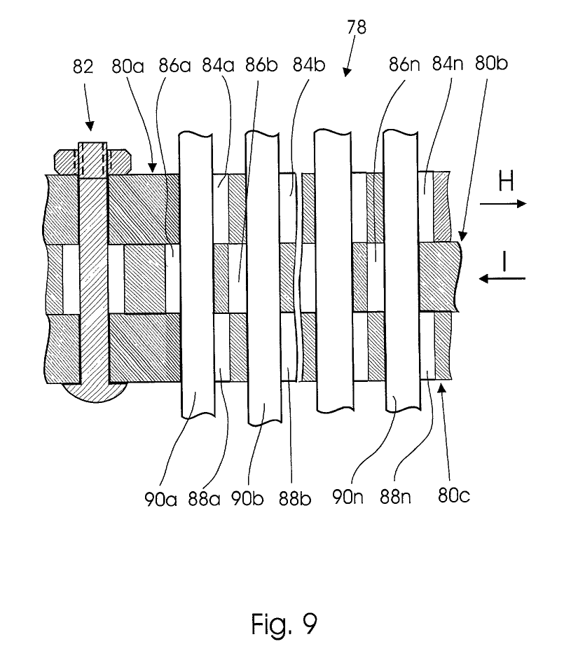

FIG. 9 is a fragmental sectional side view of a fiber-clamping device made according to another embodiment of the invention. The remaining part of the multiple fiber-lens coupling system is the same as in the previous embodiments of the invention. As shown in FIG. 9, a fiber-clamping device 78 consists of a stack of three perforated plates 80a, 80b, 80c. The plates 80a and 80c are rigidly connected to each other, e.g., by screws, such as a screw 82, while the plate 80b, which is sandwiched between the plates 80a and 80c, can slide in the directions shown by arrows H and I. Alternatively, the plates 80a and 80c can be connected by a layer of glue applied onto the edges of the plate so that a gap with a thickness equal to the thickness of the plate 80b is formed between the plates 80a and 80c. The plate 80a has perforations 84a, 84b, . . . 84n; the plate 80b has perforations 86a, 86b, . . . 86n; and the plate 80c has perforations 88a, 88b, . . . 88n. The perforations of all three plates 80a, 80b, and 80c may have the same diameters, matrix arrangements, and dimensional ratios with respect to the optical fibers 90a, 90b, . . . 90n as in the embodiments of FIGS. 1-8. The embodiment of FIG. 9 is applicable to both the array and the matrix arrangements.

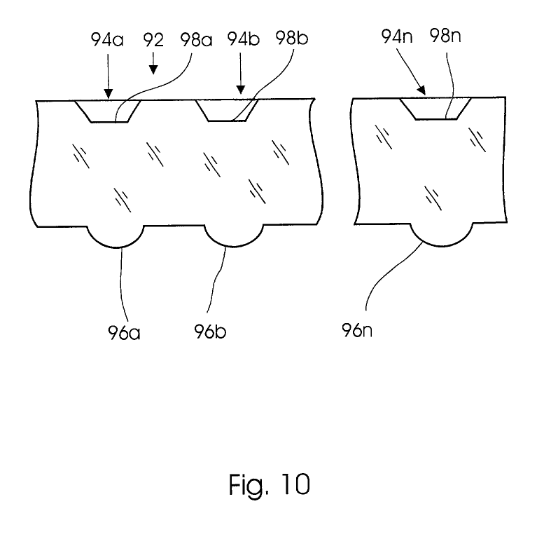

FIG. 10 is a fragmental sectional view of a microlens array/matrix 92 in which the fiber-aligning craters are replaced by tapered holes 94a, 94b, . . . 94n which are made in flush with the surface of the microlens array/matrix 92 on the side opposite to the respective microlenses 96a, 96b, . . . 96n. The tapered holes 94a, 94b, . . . 94n are coaxial with the respective microlenses 96a, 96b, . . . 96n and have flat bottoms 98a, 98b, . . . 98n.

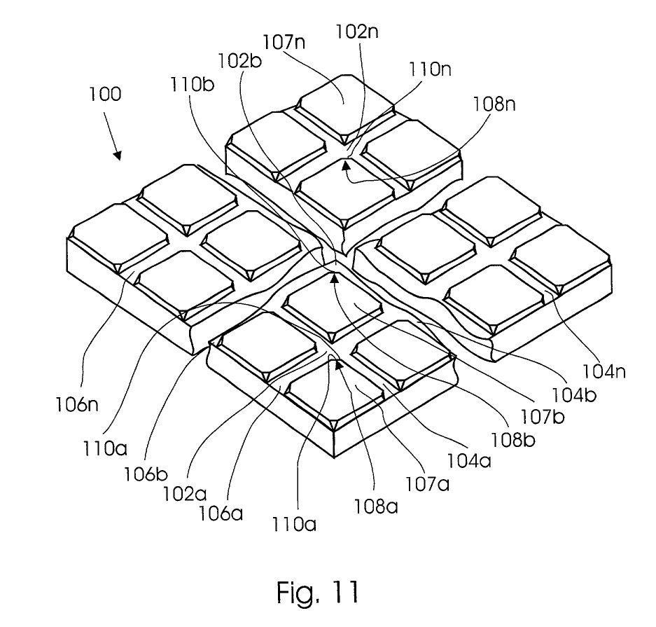

FIG. 11 is a three-dimensional view of a portion of a microlens matrix 100 with tapered fiber-aligning cells 102a, 102b, . . . 102n formed by cutting equally spaced grooves 104a, 104b, . . . 104n in one direction and equally spaced grooves 106a, 106b, . . . 106n in a direction perpendicular to grooves 104a, 104b, . . . 104n with subsequent etching of the matrix 100. Since corners 108a, 108b, . . . 108n of the raised squares or rectangles 107a, 107b, . . . 107n formed by the mutually perpendicular grooves 104a, 104b, . . . 104n and 106a, 106b, . . . 106n are etched from both sides simultaneously, they will have higher rate of etching than the sides of the raised elements. As a result, they are formed into downwardly tapered surfaces 110a, 110b, . . . 110n that, in combination with flat surfaces formed by the grooves can be used for centering and aligning the end faces of the fibers (not shown) assembled into a bundle.

In other words, the fiber self-aligning means shown in FIG. 11 is formed by square projections 107a, 107b, . . . 107n projecting from the side of the microlens facing the optical fibers and having equally inclined surfaces 110a, 110b, . . . 110n tapered towards the microlenses (not shown in FIG. 11). The inclined surfaces are located diagonally opposite each other on the corners of the projections.

It should be noted that in all aforementioned embodiments flat bottoms are strictly perpendicular to optical axes of their respective microlenses.

During assembling of the systems shown in FIGS. 1 and 6, the perforated plates 26, 28 (FIG. 1), 60, 62 (FIG. 6), or the plate 80b with respect to the plates 80a and 80c (FIG. 9) are stacked together so that their perforations are aligned, and the fibers, which has been preliminarily packed into a bundle forming in the bundle cross section a rectangular, square, or a hexagonal cross-sectional lattice arrangement, are passed through the aligned openings 34a, 34b, . . . 34n, 32a, 32b, . . . 32n (FIG. 1), 72a, 72b, . . . 72n, 70a, 70b, . . . 70n (FIG. 6), or 84a, 84b, . . . 84n, 86a, 86b, . . . 86n, 88a, 88b, . . . 88n (FIG. 9). The projecting ends of the respective fibers are inserted into the tapered craters till gap-free contacts with the crater bottoms 30-1, 30-2, . . . 30-n (FIG. 1), 44a, 44b, . . . 44n, 66-1, 66-2, . . . 66-n (FIGS. 5 and 6), or to the bottoms 98a, 98b, . . . 98n of the tapered holes (FIG. 10), as well as to the flat surfaces 102a, 102b, . . . 102n of the grooves 104a, 104b, . . . 104n, 106a, 106b, . . . 106n surrounded by four inclined surfaces shown in FIG. 11.

The fibers 20a, 20b, . . . 20n (FIG. 1), 56a, 56b, . . . 56n (FIG. 6), etc., are then clamped to fix their position in the bundles by shifting either one plate with respect to the other or both plates with respect to each other in the respective fiber-clamping device. In FIG. 1, FIG. 6, and FIG. 9, as well as in respective end views of FIGS. 7 and 8 the fibers 20a, 20b, . . . 20n (FIG. 1), 56a, 56b, . . . 56n (FIG. 6), etc., are shown in a clamped positions provided by relative displacements of the plates in the fiber-clamping devices. In other words, the plates are shifted away from the aligned positions until their side surfaces come to contact with the fibers and fix them against movement in the lateral direction. The embodiment of FIG. 9 with the movement of plate 80b with respect to the stationary plates 80a and 80c provides more uniform distribution of pressure applied from the sides of the plate openings top the side surfaces of the fibers.

The fiber clamping method described above is equally applicable to fibers with buffer layers as well as to the fibers stripped from the buffer layers. It is understood that in the first case the ends of the buffered fibers have to be stripped from the buffer layer, which is required for butt connection with the aforementioned flat bottoms of the tapered openings.

The surfaces of the microlens arrays or matrices that face the ends of the clamped fibers are preliminarily coated with liquid glue, preferably UV curable glue, optically matched with the material of the microlenses and the fibers. This glue is shown by reference numeral 36 in FIG. 1. When the ends of the clamped fibers enter the aligning holes or craters, the glue is squeezed out from the holes or craters.

After alignment is achieved and checked by the positions of light spots, e.g., with the use of Spirikon camera or a similar device (not shown), the adjusted positions of the fibers are fixed by curing a layer of the UV-curable glue, such as the glue 36, by light propagated from the lens-side of the plate. Upon completion of the alignment and connection of the fiber ends to the microlens elements, the clamping plates can be removed from the opposite end of the bundle.

Thus it has been shown that the invention provides a multiple fiber-lens coupling system and method for self-aligning and coupling a bundle of individual optical fibers to a matrix or array of respective optical lenses in a simple and reliable manner. In a cross-sectional view, the optical fibers are arranged in a lattice structure with matching and coupling of the fiber ends to respective microlenses. Plurality of fiber-lens pairs are fixed to each other in an optimal optically-matched positions with self-aligning of the fibers during optical matching. The system of the invention is inexpensive to manufacture and is suitable for mass production.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the microlenses and fibers can be arranged in patterns different from square and hexagonal, e.g., in a parallelogram type pattern, or any other arbitrary pattern. The openings formed in the clamping plates may have a square, rectangular, elliptical, or any other configuration. They can be formed by etching, drilling, piercing, etc. The clamping plates can be made of any material including metal. The matrix may have a round or any other configuration in a top view. The microlenses can be made of an optical plastic. The microlenses can be spherical or aspherical. The parts 40a and 40b of FIG. 5 can be spaced from each other, provided that the condition of optical matching between the fibers and microlenses is not violated. The ends of the fibers can be attached to the lens elements by soldering, fusing, welding, etc. Although the device and method of the invention were shown and illustrated for a plurality of micro lenses and optical fibers, the same principle is applicable for aligning and self-matching a single fiber to a single micro lens.

1. A fiber-lens coupling system comprising: at least one optical fiber; at least one fiber clamping means for clamping said optical fiber in said clamping means; and at least one micro lens device having a fiber self-aligning means on the side facing said at least one optical fiber and at least one micro lens on the side opposite to said at least one optical fiber, said at least one micro lens having an optical axis which is aligned with said fiber self-aligning means.

2. The fiber-lens coupling system of claim 1, wherein said at least one fiber self-aligning means comprises a tapered opening having a flat bottom strictly perpendicular to said optical axis of said micro lens.

3. The fiber-lens coupling system of claim 2, wherein said at least one optical fiber has a longitudinal direction and an end face, on the side facing said fiber self-aligning means, which is strictly perpendicular to said longitudinal direction, said end face being in butt connection with said flat bottom.

4. The fiber-lens coupling system of claim 3, wherein said at least one fiber self-aligning means comprises a crater-like projection and wherein said tapered opening is located in said crater-like projection.

5. The fiber-lens coupling system of claim 3, wherein said tapered opening is formed in flush with the side facing said at least one optical fiber.

6. The fiber-lens coupling system of claim 3, wherein said at least one fiber self-aligning means comprises projecting portions having corners and projecting from said side facing said at least one optical fiber and having equally inclined surfaces tapered towards said at least one microlens, said inclined surfaces being located opposite each other on said corners.

7. The fiber-lens coupling system of claim 6, wherein said projecting portions having rectangular shapes with said inclined surfaces formed on the corners of said rectangular shapes, said projections being formed by cutting flat mutually perpendicular grooves in said side facing said at least one optical fiber.

8. The fiber-lens coupling system of claim 6, wherein said inclined surfaces are formed by etching.

9. The fiber-lens coupling system of claim 7, wherein said inclined surfaces are formed by etching.

10. The fiber-lens coupling system of claim 1, wherein said at least one optical fiber has a diameter, said at least one fiber clamping means comprises: a first perforated plate having at least one first opening with a diameter exceeding said diameter of said at least one optical fiber; and a second perforated plate having at least one second opening with a diameter exceeding said diameter of said at least one optical fiber; said at least one optical fiber being guided through said at least one first opening and said at least one second opening; at least one of said first perforated plate and said second perforated plate being moveable with respect to the other in a direction of clamping said at least one fiber.

11. The fiber-lens coupling system of claim 10, wherein said at least one fiber self-aligning means comprises a tapered opening having a flat bottom strictly perpendicular to said optical axis of said microlens.

12. The fiber-lens coupling system of claim 11, wherein said at least one optical fiber has a longitudinal direction and an end face, on the side facing said fiber self-aligning means, which is strictly perpendicular to said longitudinal direction, said end face being in butt connection with said flat bottom.

13. The fiber-lens coupling system of claim 11, wherein said at least one fiber self-aligning means comprises a crater-like projection and wherein said tapered opening is located in said crater-like projection.

14. The fiber-lens coupling system of claim 11, wherein said tapered opening is formed in flush with the side facing said at least one optical fiber.

15. The fiber-lens coupling system of claim 11, wherein said at least one fiber self-aligning means comprises projecting portions having corners and projecting from said side facing said at least one optical fiber and having equally inclined surfaces tapered towards said at least one microlense, said inclined surfaces being located opposite each other on said corners.

16. The fiber-lens coupling system of claim 15, wherein said projecting portions having rectangular shapes with said inclined surfaces formed on the corners of said rectangular shapes, said projecting portions being formed by cutting flat mutually perpendicular grooves in said side facing said at least one optical fiber.

17. The fiber-lens coupling system of claim 15, wherein said inclined surfaces are formed by etching.

18. The fiber-lens coupling system of claim 16, wherein said inclined surfaces are formed by etching.

19. The fiber-lens coupling system of claim 1, wherein said at least one optical fiber has a diameter, said at least one fiber clamping means comprises: a first perforated plate having at least one first opening with a diameter exceeding said diameter of said at least one optical fiber; a second perforated plate having at least one second opening with a diameter exceeding said diameter of said at least one optical fiber; and a third perforated plate having at least one third opening with a diameter exceeding said diameter of said at least one optical fiber; said at least one optical fiber being guided through said at least one first opening, said at least at least one second opening, and said at least one third opening; said first perforated plate being fixed with respect to said third perforated plate and said at least one first opening is aligned with said at least one third opening, said second perforated plate being sandwiched between said first perforated plate and said third perforated plate and is moveable with respect thereto in a direction of clamping said at least one optical fiber.

20. The fiber-lens coupling system of claim 19, wherein said at least one fiber self-aligning means comprises a tapered opening having a flat bottom strictly perpendicular to said optical axis of said micro lens.

21. The fiber-lens coupling system of claim 20, wherein said at least one optical fiber has a longitudinal direction and an end face, on the side facing said fiber self-aligning means, which is strictly perpendicular to said longitudinal direction, said end face being in butt connection with said flat bottom.

22. The fiber-lens coupling system of claim 20, wherein said at least one fiber self-aligning means comprises a crater-like projection and wherein said tapered opening is located in said crater-like projection.

23. The fiber-lens coupling system of claim 20, wherein said tapered opening is formed in flush with the side facing said at least one optical fiber.

24. The fiber-lens coupling system of claim 20, wherein said at least one fiber self-aligning means comprises projecting portions having corners and projecting from said side facing said at least one optical fiber and having equally inclined surfaces tapered towards said at least one microlens, said flats being located opposite each other on said corners.

25. The fiber-lens coupling system of claim 24, wherein said projecting portions having rectangular shapes with said inclined surfaces formed on the corners of said rectangular shapes, said projecting portions being formed by cutting flat mutually perpendicular grooves in said side facing said at least one optical fiber.

26. The fiber-lens coupling system of claim 24, wherein said inclined surfaces are formed by etching.

27. The fiber-lens coupling system of claim 25, wherein said inclined surfaces are formed by etching.

28. A fiber-lens coupling system comprising: a plurality of individual optical fibers assembled into a fiber bundle; at least one fiber clamping means for clamping said fiber bundle in said clamping means; and a microlenses device having a plurality of individual fiber self-aligning means on the side facing said fiber bundle and a plurality of individual microlenses on the side opposite to said fiber bundle, each said individual microlens of said plurality of individual microlenses having an optical axis which is aligned with a respective individual fiber self-aligning means of said plurality.

29. The fiber-lens coupling system of claim 28, wherein each said individual fiber self-aligning means comprises a tapered opening having a flat bottom strictly perpendicular to said optical axis.

30. The fiber-lens coupling system of claim 29, wherein each said individual optical fiber has a longitudinal direction and an end face, on the side facing said fiber self-aligning means, which is strictly perpendicular to said longitudinal direction, said end face being in butt connection with said flat bottom.

31. The fiber-lens coupling system of claim 30, wherein each said individual fiber self-aligning means comprises a crater-like projection and wherein said tapered opening is located in said crater-like projection.

32. The fiber-lens coupling system of claim 30, wherein said tapered opening is formed in flush with the side facing said fiber bundle.

33. The fiber-lens coupling system of claim 30, wherein said individual fiber self-aligning means comprises projecting portions having corners and projecting from said side facing said fiber bundle and having equally inclined surfaces tapered towards said respective individual microlens, said inclined surfaces being located opposite each other on said corners.

34. The fiber-lens coupling system of claim 33, wherein said projecting portions having rectangular shapes with said inclined surfaces formed on the corners of said rectangular shapes, said projecting portions being formed by cutting flat mutually perpendicular grooves in said side facing said fiber bundles.

35. The fiber-lens coupling system of claim 33, wherein said inclined surfaces are formed by etching.

36. The fiber-lens coupling system of claim 34, wherein said inclined surfaces are formed by etching.

37. The fiber-lens coupling system of claim 28, wherein each said individual optical fiber of said fiber bundle has a diameter, said at least one fiber clamping means comprises: a first perforated plate having a plurality of first openings with a diameter exceeding said diameter of said individual optical fibers of said plurality; and a second perforated plate having a plurality of second openings with a diameter exceeding said diameter of said individual optical fibers of said plurality; individual optical fibers being guided through said first openings and said second openings; at least one of said first perforated plate and said second perforated plate being moveable with respect to the other in a direction of clamping said individual optical fibers.

38. The fiber-lens coupling system of claim 37, wherein each said individual fiber self-aligning means comprises a tapered opening having a flat bottom strictly perpendicular to said optical axis of said microlens.

39. The fiber-lens coupling system of claim 38, wherein each said individual optical fiber has a longitudinal direction and an end face, on the side facing said fiber self-aligning means, which is strictly perpendicular to said longitudinal direction, said end face being in butt connection with said flat bottom.

40. The fiber-lens coupling system of claim 39, wherein each said individual fiber self-aligning means comprises a crater-like projecting portion and wherein said tapered opening is located in said crater-like projecting portion.

41. The fiber-lens coupling system of claim 39, wherein said tapered opening is formed in flush with the side facing said fiber bundle.

42. The fiber-lens coupling system of claim 39, wherein each said individual fiber self-aligning means comprises projecting portions having corners and projecting from said side facing said fiber bundle and having equally inclined surfaces tapered towards said respective individual microlens, said inclined surfaces being located opposite each other on said corners.

43. The fiber-lens coupling system of claim 42, wherein each said projecting portion has a rectangular shape with said inclined surfaces formed on the corners of said rectangular shapes, said projecting portions being formed by cutting flat mutually perpendicular grooves in said side facing said fiber bundle.

44. The fiber-lens coupling system of claim 43, wherein said inclined surfaces are formed by etching.

45. The fiber-lens coupling system of claim 42, wherein said inclined surfaces are formed by etching.

46. The fiber-lens coupling system of claim 37, wherein each said individual optical fiber has a diameter, said at least one fiber clamping means comprises: a first perforated plate having a plurality of first openings with a diameter exceeding said diameter of each said individual optical fiber; a second perforated plate having a plurality of second openings with a diameter exceeding said diameter of each said individual optical fiber; and a third perforated plate having a plurality of third openings with a diameter exceeding said diameter of each said individual optical fiber; individual optical fibers being guided through said first openings, said second openings, and said third openings; said first perforated plate being fixed with respect to said third perforated plate and said first openings are aligned with said third openings, said second perforated plate being sandwiched between said first perforated plate and said third perforated plate and is moveable with respect thereto in a direction of clamping said individual optical fibers.

47. The fiber-lens coupling system of claim 46, wherein each said individual fiber self-aligning means comprises a tapered opening having a flat bottom strictly perpendicular to said optical axis of said microlens.

48. The fiber-lens coupling system of claim 47, wherein each said individual optical fiber has a longitudinal direction and an end face, on the side facing said fiber self-aligning means, which is strictly perpendicular to said longitudinal direction, said end face being in butt connection with said flat bottom.

49. The fiber-lens coupling system of claim 48, wherein each said individual fiber self-aligning means comprises a crater-like projecting portion and wherein said tapered opening is located in said crater-like projecting portion.

50. The fiber-lens coupling system of claim 48, wherein said tapered opening is formed in flush with the side facing said fiber bundle.

51. The fiber-lens coupling system of claim 48, wherein each said individual fiber self-aligning means comprises projecting portions having corners and projecting from said side facing said fiber bundle and having equally inclined surfaces tapered towards said respective individual microlens, said inclined surfaces being located opposite each other on said corners.

52. The fiber-lens coupling system of claim 51, wherein each said projecting portion has a rectangular shape with said inclined surfaces formed on the corners of said rectangular shapes, said projecting portions being formed by cutting flat mutually perpendicular grooves in said side facing said fiber bundle.

53. The fiber-lens coupling system of claim 51, wherein said inclined surfaces are formed by etching.

54. The fiber-lens coupling system of claim 52, wherein said inclined surfaces are formed by etching.

55. The fiber-lens coupling system of claim 37, wherein said individual optical fibers in said fiber bundle, said respective individual fiber self-aligning means, said individual microlenses, said first openings, and said second openings are aligned with each other and are arranged in the form selected from an array and a matrix and in a lattice pattern selected from rectangular and hexagonal.

56. The fiber-lens coupling system of claim 39, wherein said individual optical fibers in said fiber bundle, said respective individual fiber self-aligning means, said individual microlenses, said first openings, and said second openings are aligned with each other and are arranged in the form selected from an array and a matrix and in a lattice pattern selected from rectangular and hexagonal.

57. The fiber-lens coupling system of claim 46, wherein said individual optical fibers in said fiber bundle, said respective individual fiber self-aligning means, said individual microlenses, said first openings, said second openings, and said third openings are aligned with each other and are arranged in the form selected from an array and a matrix and in a lattice pattern selected from rectangular and hexagonal.

58. The fiber-lens coupling system of claim 48, wherein said individual optical fibers in said fiber bundle, said respective individual fiber self-aligning means, said individual microlenses, said first openings, said second openings, and said third openings are aligned with each other and are arranged in the form selected from an array and a matrix and in a lattice pattern selected from rectangular and hexagonal.

59. A method of manufacturing a fiber-lens coupling system comprising:
assembling a plurality of individual optical fibers into a fiber bundle with a specific pattern in a direction perpendicular to said bundle, each individual optical fiber of said bundle having an end face;
providing an optical lens device having one side facing said fiber bundle and another side opposite to said one side, said optical lens device having a plurality of individual fiber-self-aligning means on said one side and a plurality of individual microlenses on said another side, said individual microlenses and said individual self-aligning means being arranged in said specific pattern, said individual microlenses having parallel optical axes;
providing at least one fiber clamping device close to said end faces of said individual optical fibers, said at least one clamping device being capable of clamping said bundle against movements of said individual optical fibers near said end faces in said perpendicular direction;
aligning said end faces of said individual optical fibers to arrange them in one plane, said end faces facing said one side;
clamping said individual optical fibers against movements in said perpendicular direction with the use of said at least one fiber clamping device;
coating said one side with a liquid curable glue;
inserting said end faces of said individual optical fibers into said individual self-aligning means to form butt connections with said one side of said optical lens device thus aligning and optically matching said individual optical fibers with said respective individual microlenses; and
fixing said individual optical fibers to said one side of said optical lens device by curing said liquid glue.

60. The method of claim 59, wherein said step of aligning said end faces is carried out by shifting said end faces against a flat surface parallel to said one side.

61. The method of claim 60, wherein said step of aligning further includes adjustment by checking positions of light spots produced by projecting a light through said bundle from the side opposite to said end faces onto a plane arranged in said perpendicular direction.

62. The method of claim 59, wherein each said individual fiber-self-aligning means comprises a tapered opening having a flat bottom strictly perpendicular to said optical axes.

63. The method of claim 62, wherein each said individual fiber self-aligning means comprises a crater-like projection and wherein said tapered opening is located in said crater-like projection.

64. The method of claim 62, wherein said tapered opening is formed in flush with the side facing said fiber bundle.

65. The method of claim 59, wherein said individual fiber-self-aligning means are produced by photolithography.

66. The method of claim 62, wherein said tapered opening is produced by photolithography.

67. The method of claim 63, wherein said crater-like projection is produced by photolithography.

68. The method of claim 64, wherein said tapered opening, which is formed in flush, is produced by photolithography.
